(19) United States
(12) Patent Application Publication
(10) Pub. No.: US 2011/0200745 A1
(43) Pub. Date: Aug. 18, 2011

(54) REINFORCING BAR MATERIAL COATED WITH HIGH ADHESION ANTICORROSION FILM AND METHOD OF PRODUCING THE SAME

(76) Inventors: Teruhiko SUGIMOTO, Osaka (JP); Rikuta Murakami, Osaka (JP); Mitsuru Takeuchi, Osaka (JP); Yasuhiro Arai, Kakogawa (JP); Hiroki Arai, Kakogawa (JP); Kaoru Arai, Akashi (JP); Yasuharu Kida, Akashi (JP)

(21) Appl. No.: 13/097,414

(22) Filed: Apr. 29, 2011

Related U.S. Application Data
(62) Division of application No. 11/826,470, filed on Jul. 16, 2007.

(51) Int. Cl. B05D 5/00; B05D 3/02; B05D 1/12

(52) U.S. Cl. 427/195

(57) ABSTRACT

A reinforcing bar material is coated with a high adhesion anticorrosion film that increases adhesion strength to concrete. The film is applied by heating a reinforcing bar material, spraying and melt-adhering an epoxy powder coating material onto the reinforcing bar material while a temperature on a surface of the reinforcing bar material is between 200 and 250° C. so as to form a first anticorrosion film, and under the same temperature condition spraying and melt-adhering an epoxy powder coating material with acrylic resin beads having a particle diameter 2.5 to 3 times that of the epoxy resin powder mixed in on a surface of the first anticorrosion film in a molten state so as to form a second anticorrosion film having numerous projections, thereby providing a coating without pinholes.

### FIELD OF THE INVENTION

The present invention relates to a reinforcing bar material coated with an anticorrosion film having enhanced adhesion to concrete.

### DESCRIPTION OF THE PRIOR ART

In recent years, corrosion of a reinforcing bar has proceeded as a result of an influence of concrete aggregate etc., and thus various accidents frequently occur. Therefore, as shown in Japanese Examined Patent Publication No. 6-16868, there is developed a reinforcing bar coated with epoxy in which an epoxy powder coating material is sprayed and melt-adhered on the surface of the heated reinforcing bar material so as to form an anticorrosion film. With the development, a corrosion problem of the reinforcing bar seems to be tentatively resolved, excluding problems such as pinholes which are inevitably formed in an anticorrosion film.

However, as shown in “The Guideline for Design and Construction of Reinforced Concrete using Reinforcing Bar Coated with Epoxy Resin (draft)”, Concrete Library, Japan Society of Civil Engineering, No. 58, page 19, it is known that when epoxy coating is applied to reinforcing bar material, a long term adhesion strength to concrete decreases to approximately 80% of that between uncoated reinforcing bar material and concrete. This has a serious influence on the strength of a concrete structure, and is a critical problem involving the life span of the structure.

The invention described in Japanese Unexamined Patent Publication No. 2001-90254 was proposed in order to resolve such a problem, and is characterized in that, in a reinforcing bar material coated with an anticorrosion film formed by using a synthetic resin powder coating material (for example, thermoplastic polyethylene isophthalate terephthalate copolymer), adhesion to concrete is enhanced by spraying inorganic granules such as ceramic and glass powders, for example, silica sand and alumina powder on a surface of the anticorrosion film.

The conventional example will be explained as follows with reference to FIGS. 4-A to 4-E. First, as shown in FIG. 4-A, a reinforcing bar material 41 is subjected to shot blasting so as to remove rust and dirt on the surface of the reinforcing bar material 41 and to roughen the surface of the reinforcing bar material 41 to from a roughened surface. Then, as shown in FIG. 4-B, the reinforcing bar material 41 is heated and, as shown in FIG. 4-C, a synthetic resin powder coating material 44 is sprayed and melt-adhered on the surface of the reinforcing bar material 41 heated at a predetermined temperature (260 to 400° C.). Then, as shown in FIG. 4-D, an inorganic granular substance 40a is sprayed while the synthetic resin powder coating material 44 is in a molten state. As shown in FIG. 4-E, after passing through a cooling process to obtain a reinforcing bar material coated with a high adhesion anticorrosion film is obtained, wherein the inorganic granular substance 40a is firmly fixed on the surface of an anticorrosion film 42.

According to the conventional example, when the inorganic granular substance 40a is sprayed while the synthetic resin powder coating material 44 is in a molten state, a portion of the inorganic granular substance 40a is embedded in the anticorrosion film 42 and fixed therein, while the other portion is exposed on the surface of the anticorrosion film 42 to form countless projections (irregularities). As a result, adhesion to concrete is improved, although the reinforcing bar material is coated with an anticorrosion film.

However, in the conventional example, a different kind of a material is adhered on the surface of the anticorrosion film 42. Although a portion of the inorganic granular substance 40a is pressed in and adhered to the anticorrosion film 42, the inorganic granular substance 40a is likely to be exfoliated by contacting with other substances, and it is assumed that the adhesion performance remarkably decreases due to deterioration with time of the anticorrosion film 42.

Also, when a synthetic resin powder coating material 44 such as an epoxy powder coating material is sprayed and melt-adhered on the heated reinforcing bar material 41 to form the anticorrosion film 42, it is generally inevitable that several pin holes (minimal air bubbles) are formed per meter on the reinforcing bar material. Therefore, it is a current status that a pin hole test is conducted throughout the entire length of every product to confirm that the number of pin holes is less than a permissible number before shipping to factories, but in the above conventional example, since a single layer of the anticorrosion film 42 is formed and the inorganic granular substance 40a is sprayed on the surface, pin holes formed in the single layer of the anticorrosion film 42 remain intact as a defect in terms of anticorrosion performance.

As a solution means of such a problem, the applicants of the present application have developed and already proposed in Japanese Unexamined Patent Publication No. 2005-66574 a method for producing a reinforcing bar material coated with a high adhesion anticorrosion film, which comprises forming two layers of anticorrosion films on the surface of a reinforcing bar material by spraying a powder coating material on it so as to solve a pin hole problem that inevitably occurs in an anticorrosion film, and also forming countless projections by the second layer of anticorrosion film so as to increase adhesion strength to concrete.

The production method comprises heating a reinforcing bar material, spraying and melt-adhering an epoxy powder coating material onto the reinforcing bar material while the surface temperature of the reinforcing bar material is between 250 and 390° C. so as to form a first anticorrosion film, and then, under this temperature condition, spraying and melt-adhering a zinc-rich powder coating material (powder coating material composed of mixture of zinc metal powder, epoxy resin and curing agent) onto a surface of the first anticorrosion film in a molten state so as to form a second anticorrosion film, followed by cooling the reinforcing bar material coated with the first and second anticorrosion films so as to produce a reinforcing bar material coated with a high adhesion anticorrosion film that has countless projections formed by the second anticorrosion film.

According to this method, even if pin holes are formed in the first layer of anticorrosion film, the second layer of anticorrosion film is formed on the first layer of anticorrosion film in a molten state and therefore the pin holes in the first layer of anticorrosion film are restored. Even if the pin holes remain without being restored, the probability that the pin holes in the first anticorrosion film conform with those on the second anticorrosion film is almost zero, so that a defect in anticorrosion performance resulting from the pin holes in the first anticorrosion film is compensated by the second anticorrosion film, and a defect in anticorrosion performance resulting from the pin holes in the second anticorrosion film is compensated by the first anticorrosion film, and thereby high anticorrosion performance is secured.

Furthermore, since the second anticorrosion film is formed with a zinc-rich powder coating material on the first anticorrosion film made of an epoxy powder coating material and adhesion strength to concrete increases by virtue of countless projections formed on the second anticorrosion film, a concern that projections are exfoliated by contacting other objects is eliminated unlike the case where projections are formed by adhesion of another kind of granular substance to a surface of an anticorrosion film, and thus high anticorrosion performance is secured over a long period of time.

However, it was learned that there remains some room for improvement in the following matters in the previously proposed method. That is, first, it is preferable that spray coating of an epoxy powder coating material is conducted under a temperature condition as low as possible because performance of an epoxy resin decreases at a high temperature. However, in the method above, a granular substance mixed in an epoxy powder coating material for forming the second anticorrosion film is a zinc metal powder (inorganic granular substance) and therefore in order to exhibit it as a firm projection coated with a binder component (epoxy resin) on a surface of the second anticorrosion film, it is necessary that spray coating is conducted on the second layer under a high temperature condition of 250 to 390° C., and therefore it is hard to maintain performance of an epoxy resin.

Second, when an antirust performance test is conducted at a high temperature, zinc (zinc component) exerts an adverse influence on an epoxy resin, thereby causing deterioration of an epoxy resin component, which may lead to a future defect according to the purposes such as heating furnace structures.

Third, zinc shows deterioration against a chloride ion. In the above method, a zinc metal powder serves as a projection in a state coated with an epoxy resin as a binder component so as to be protected by a coating layer, but when cracks are formed on the coating layer, deterioration by a chloride ion potentially occurs, which may lead to a future defect according to a use such as harbors structure and marine structures.

The present invention is improved in the above matters, and the purpose thereof is to provide a reinforcing bar material coated with a high adhesion anticorrosion film that provides an increase in adhesion strength to concrete, which comprises forming two layers of anticorrosion films on a surface of a reinforcing bar material by means of spraying an epoxy powder coating material under a temperature condition where performance of the epoxy resin can be retained, so as to solve a pin hole problem that inevitably occurs in an anticorrosion film, and also to exhibit firm projections in a state coated with the epoxy resin on the second layer of anticorrosion film.

### SUMMARY OF THE INVENTION

A technical means that the present invention has taken in order to achieve the purpose described above is as follows. That is, a reinforcing bar material coated with a high adhesion anticorrosion film by the present invention is characterized by comprising forming a first anticorrosion film using an epoxy powder coating material on a surface of a reinforcing bar material, forming a second anticorrosion film using an epoxy powder coating material with acrylic resin beads having a particle diameter 2.5 to 3 times that of the epoxy resin powder mixed in on a surface of the first anticorrosion film, and increasing adhesion strength to concrete by countless projections formed by the second anticorrosion film.

The method for producing a reinforcing bar material coated with a high adhesion anticorrosion film of the present invention is characterized by comprising heating a reinforcing bar material, spraying and melt-adhering an epoxy powder coating material onto the reinforcing bar material while a temperature on a surface of the reinforcing bar material is between 200 and 250° C. so as to form a first anticorrosion film, and also, under this temperature condition, spraying and melt-adhering an epoxy powder coating material with acrylic resin beads having a particle diameter 2.5 to 3 times that of the epoxy resin powder mixed in on a surface of the first anticorrosion film in a molten state so as to form a second anticorrosion film, followed by cooling the reinforcing bar material coated with the first and second anticorrosion films to prepare the reinforcing bar material coated with a high adhesion anticorrosion film having countless projections formed by the second anticorrosion film.

According to a reinforcing bar material coated with a high adhesion anticorrosion film of the present invention, even if pin holes are formed in the first layer of anticorrosion film, the second layer of anticorrosion film is formed on the first layer of anticorrosion film in a molten state and therefore the pinholes in the first layer of anticorrosion film are restored. Even if the pin holes remain without being restored, the probability that the pin holes in the first anticorrosion film conform with those in the second anticorrosion film is almost zero, so that a defect in anticorrosion performance resulting from the pin holes in the first anticorrosion film is compensated by the second anticorrosion film, and a defect in anticorrosion performance resulting from the pin holes in the second anticorrosion film is compensated by the first anticorrosion film, and thereby high anticorrosion performance is secured.

Furthermore, since the second anticorrosion film is formed by an epoxy powder coating material with acrylic resin beads having a particle diameter 2.5 to 3 times that of the epoxy resin powder mixed in on the first anticorrosion film made of an epoxy powder coating material and adhesion strength to concrete increases by virtue of countless projections formed on the second anticorrosion film, a concern that projections are exfoliated by contacting other objects, or the like is eliminated unlike the case where projections are formed by adhesion of another kind of granular substance to a surface of an anticorrosion film, and thereby high anticorrosion performance is secured over a long period of time.

According to the method for producing a reinforcing bar material coated with a high adhesion anticorrosion film by the present invention, a reinforcing bar material coated with a high adhesion anticorrosion film can be prepared. That is, by heating a reinforcing bar material and spraying and melt-adhering an epoxy powder coating material onto the reinforcing bar material while a surface temperature of the reinforcing bar material is between 200 and 250° C., or in other words, under a low temperature condition with which performance of an epoxy resin can be retained, not only that a first anticorrosion film is formed, but that a second anticorrosion film is formed under the same temperature condition by means of spraying and melt-adhering an epoxy powder coating material with acrylic resin beads having a particle diameter, which is 2.5 to 3 times as that of the epoxy resin powder, mixed in onto a surface of the first anticorrosion film in a molten state, so that unmelted acrylic resin beads are locally embossed and firm projections coated with a binder component of an epoxy powder coating material (epoxy resin) are exhibited. In addition, since the first anticorrosion film and the second anticorrosion film are adhered in a molten state, the two layers exhibit properties similar to a single layer film and therefore exfoliation between the first and the second anticorrosion films is avoided.

Incidentally, when a preheating temperature of a reinforcing bar material is 200° C. or lower, an epoxy resin is hard to melt and accordingly it takes a longer time for spray coating of an epoxy powder coating material, while in case of 250° C. or higher, it is hard to retain performance of an epoxy resin. Also, when a particle diameter of acrylic resin beads is 2.5 times or smaller than that of an epoxy resin powder under a temperature condition of 200 to 250° C., projections made of unmelted beads are not formed on a surface of the second anticorrosion film, while when a particle diameter of acrylic resin beads is 3 times or more that of an epoxy resin powder, projections made of unmelted beads are too big to be coated with an epoxy resin completely. In other words, firm projections which do not come off easily can not be formed in any cases.

Thus, by forming a second anticorrosion film on a first anticorrosion film, not only a pin hole problem which inevitably occurs in an anticorrosion film is solved, but a concern for exfoliation of projections is eliminated because projections are exhibited in the second anticorrosion film itself by means of spraying an epoxy powder coating material with acrylic resin beads having a particle diameter, which is 2.5 to 3 times more than that of the epoxy resin powder, mixed in under a relatively lower temperature condition of 200 to 250° C. (under a temperature condition with which performance of an epoxy resin can be retained), and thus a reinforcing bar material coated with a high adhesion anticorrosion film, which secures high adhesion performance, is prepared.

### BRIEF DESCRIPTION OF THE DRAWINGS

FIG. 1 is a schematic cross sectional view showing a reinforcing bar material coated with a high adhesion anticorrosion film according to the present invention;

FIG. 2 is a schematic cross sectional view which explains adhesion performance of a reinforcing bar material coated with a high adhesion anticorrosion film to concrete according to the present invention;

FIGS. 3-A to 3-E are drawings for explaining a method for producing a reinforcing bar material coated with a high adhesion anticorrosion film according to the present invention; and

FIGS. 4-A to 4-E are drawings for explaining a method for producing a reinforcing bar material coated with a high adhesion anticorrosion film according to a prior art.

### DETAILED DESCRIPTION OF THE PREFERRED EMBODIMENTS

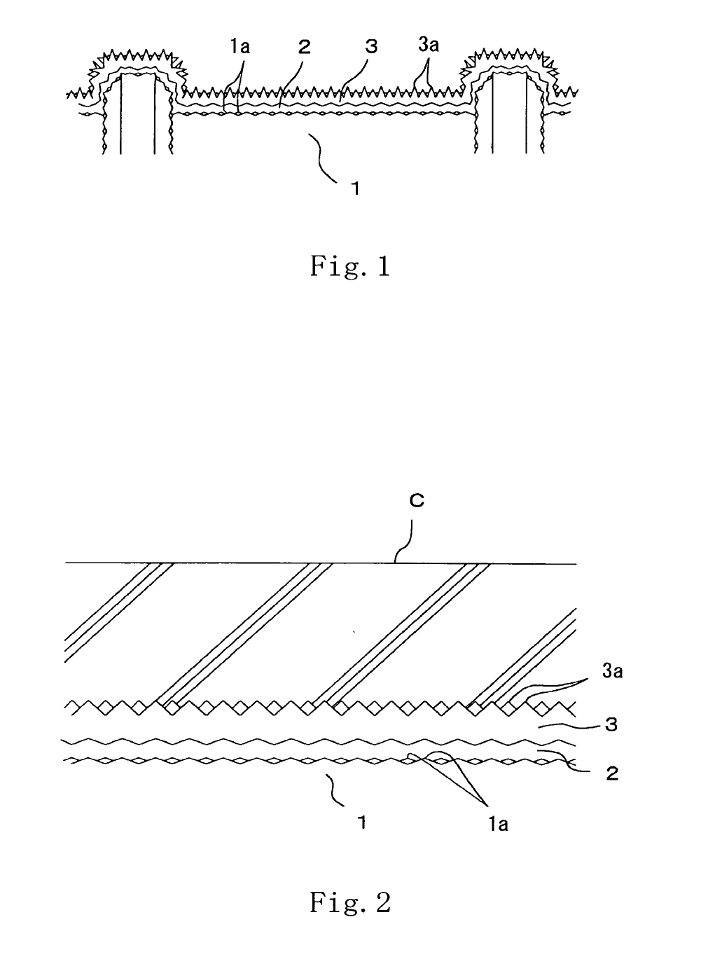

Hereinafter, the embodiment of the present invention will be described referring to the drawings, but the present invention is not limited thereto. FIG. 1 is a schematic cross sectional view showing a relevant part of an example of a reinforcing bar material coated with a high adhesion anticorrosion film according to the present invention, and FIG. 2 is a schematic cross sectional view explaining a relevant part of adhesion performance of a reinforcing bar material coated with a high adhesion anticorrosion film and concrete C. In FIG. 1 and FIG. 2, a reinforcing bar material 1 (for example, a deformed reinforcing bar material) is shown, and the surface 1a is a coarse surface coarsened by shot blasting. A first anticorrosion film 2 is formed by an epoxy powder coating material (a powder coating material composed of an epoxy resin as a base resin, a hardener and a pigment) on a surface 1a of the reinforcing bar material 1, and a second anticorrosion film 3 is formed on the first anticorrosion film 2. The second anticorrosion film 3 is formed by an epoxy powder coating material with acrylic resin beads having a particle diameter 2.5 to 3 times that of the epoxy resin powder mixed in, and has countless projections 3a formed in the second anticorrosion film 3 itself. It is composed such that the projections 3a stick into concrete C and thereby adhesion to concrete C is improved (more solid adhesion than in case of uncoated reinforcing bar). The projections 3a are in a state where unmelted acrylic resin beads are coated with an epoxy resin serving as a binder component of an epoxy powder coating material.

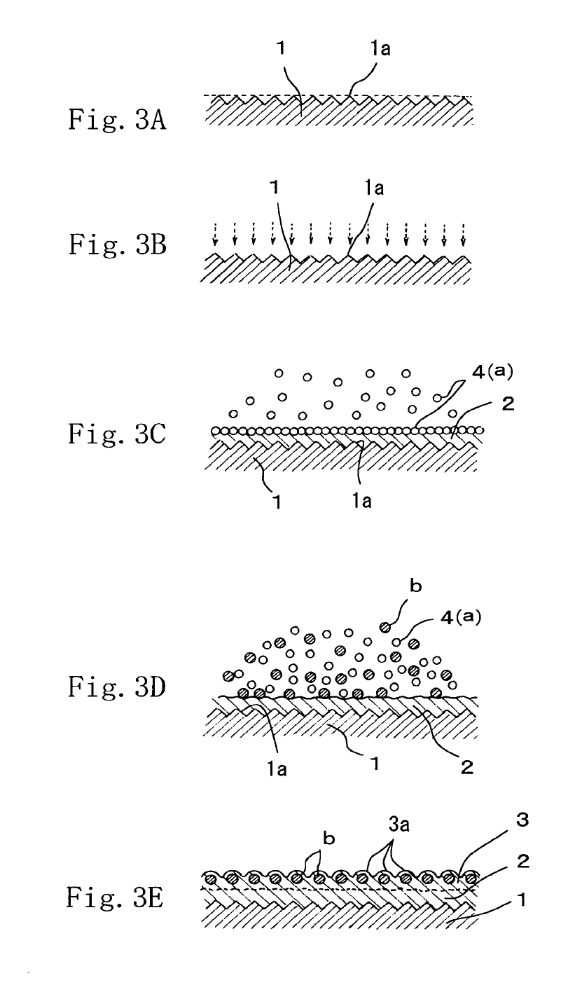

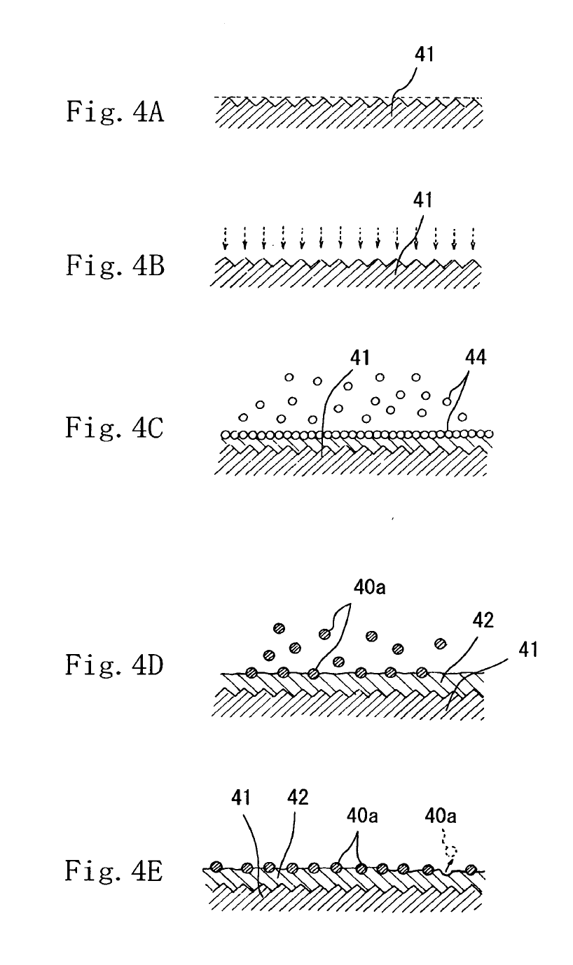

Next, a production method of an above reinforcing bar material coated with a high adhesion anticorrosion film will be explained based on FIGS. 3-A to 3-E. First, as shown in FIG. 3-A, shot blasting is conducted on the reinforcing bar material 1 to remove rust and dirt on the surface 1a of the reinforcing bar material 1, and also to coarsen the surface 1a of the reinforcing bar material 1 to make a coarse surface.

Then, as shown in FIG. 3-B, the reinforcing bar material 1 is heated at 200 to 250° C. by a known heating means.

And then, as shown in FIG. 3-C, an epoxy powder coating material 4 (a powder coating material composed of an epoxy resin powder a as a base resin, and a curing agent and pigment that are not shown in a diagram) is sprayed and melt-adhered on the surface 1a of the reinforcing bar material 1 heated at 200 to 250° C., and as shown in FIG. 3-D, the first anticorrosion film 2 having a thickness of 100 to 200 μm is formed.

Under the same temperature condition (200 to 250° C.), an epoxy powder coating material 4 with acrylic resin beads b having a particle diameter 2.5 to 3 times that of the epoxy resin powder 4a being mixed in is sprayed and melt-adhered on the surface of the first anticorrosion film 2 in a molten state, so as to form the second anticorrosion film 3 having a thickness of 100 to 200 μm, and then the reinforcing bar material coated with the first and second anticorrosion films are cooled to prepare, as shown in FIG. 3-E, a reinforcing bar material coated with a high adhesion anticorrosion film that has countless projections 3a formed by the second anticorrosion film 3.

According to the above production method, the reinforcing bar material 1 is heated in a temperature range from 200 to 250° C. where performance of an epoxy resin does not decline, and under this temperature condition (200 to 250° C.), not only that the first anticorrosion film 2 is formed by spraying an epoxy powder coating material 4, but that the second anticorrosion film 3 is formed by spraying an epoxy powder coating material 4 with acrylic resin beads b having a particle diameter 2.5 to 3 times that of the epoxy resin powder 4a being mixed in on the surface of the first anticorrosion film 2 in a molten state, so that unmelted acrylic resin beads b are locally embossed and thereby firm projections 3a are exhibited in a state coated with a binder component (epoxy resin) of the epoxy powder coating material 4. Also, since the first and second anticorrosion films are adhered in a molten state, the two layers exhibit properties similar to a single layer film and therefore exfoliation between the first and the second anticorrosion films is avoided.

Thus, the second anticorrosion film 3 is formed by means of spraying the epoxy powder coating material 4 with acrylic resin beads b having a particle diameter 2.5 to 3 times that of the epoxy resin powder a mixed in on the first anticorrosion film 2 in a molten state under a relatively lower temperature condition of 200 to 250° C., so that firm projections 3a can be exhibited in the second anticorrosion film 3 itself in a state coated with an epoxy resin, and therefore a concern for exfoliation of the projections 3a is eliminated and high adhesion performance can be secured.

In addition, since the projections 3a are formed by the acrylic resin beads b in a state coated with an epoxy resin, there is no adverse effect on an epoxy resin component even at a high temperature unlike the case where projections are formed with a zinc metal powder, and even if a coating layer of the projections 3a cracks, there is no potential of deterioration by a chloride ion unlike the case where projections are formed with a zinc metal powder.

Also, since the second anticorrosion film 3 is formed by means of spraying the epoxy powder coating material 4 with acrylic resin beads b mixed in on the first anticorrosion film 2 in a molten state, even if pin holes are formed in the first layer of anticorrosion film 2, the second layer of anticorrosion film 3 is formed thereon so as to fill pin holes in the first layer of anticorrosion film 2. And, even if the pin holes remain without being filled, the probability that the pin holes in the first anticorrosion film 2 conform with those in the second anticorrosion film 3 is almost zero, so that a defect in anticorrosion performance resulting from the pin holes in the first anticorrosion film 2 is compensated by the second anticorrosion film 3, and a defect in anticorrosion performance resulting from the pin holes in the second anticorrosion film 3 is compensated by the first anticorrosion film 2.

Accordingly, high anticorrosion performance can be provided while also preventing deterioration by a chloride ion introduced onto the epoxy resin component, unlike the configuration using a zinc metal powder.

1-2. (canceled)

3. A method of producing a reinforcing bar material coated with a high adhesion anticorrosion film, the method comprising:
heating the reinforcing bar to a temperature between 200° C. and 250° C.;
forming a first anticorrosion film by spraying and melt-adhering an epoxy powder coating material on a surface of the reinforcing bar material while the temperature of the surface of the reinforcing bar is between 200° C. and 250° C.;
forming a second anticorrosion film on a surface of the first anticorrosion film by spraying and melt-adhering the epoxy powder coating material mixed with acrylic resin beads while the temperature of the surface of the reinforcing bar is between 200° C. and 250° C.; and
cooling the reinforcing bar coated with the first anticorrosion film and the second anticorrosion film,
wherein the acrylic resin beads have a particle diameter of 2.5 to 3 times a particle diameter of the epoxy powder coating material, and
wherein the second anticorrosion film forms a plurality of projections for increasing strength of adhesion to concrete.

4. The method of claim 3, wherein the first anticorrosion film has a thickness of 100 to 200 μm.

5. The method of claim 3, wherein the second anticorrosion film has a thickness of 100 to 200 μm.

6. The method of claim 3, wherein each of the first anticorrosion film and the second anticorrosion film has a thickness of 100 to 200 μm.

7. The method of claim 3, wherein the epoxy powder coating material of the first and second anticorrosion films is adhered to the reinforcing bar in a molten state, and the projections of the second anticorrosion film are formed by unmelted acrylic beads coated with epoxy resin.

8. The method of claim 7, wherein the first anticorrosion film has a thickness of 100 to 200 μm.

9. The method of claim 7, wherein the second anticorrosion film has a thickness of 100 to 200 μm.

10. The method of claim 7, wherein each of the first anticorrosion film and the second anticorrosion film has a thickness of 100 to 200 μm.

11. The method of claim 3, wherein each of the projections is formed by one of the acrylic resin beads coated with the epoxy powder coating material.

12. The method of claim 11, wherein the first anticorrosion film has a thickness of 100 to 200 μm.

13. The method of claim 11, wherein the second anticorrosion film has a thickness of 100 to 200 μm.

14. The method of claim 11, wherein each of the first anticorrosion film and the second anticorrosion film has a thickness of 100 to 200 μm.

15. The method of claim 3, wherein the epoxy powder coating material is a powder coating material including an epoxy resin powder as a base resin, a curing agent, and a pigment.

16. The method of claim 15, wherein the first anticorrosion film has a thickness of 100 to 200 μm.

17. The method of claim 15, wherein the second anticorrosion film has a thickness of 100 to 200 μm.

18. The method of claim 15, wherein each of the first anticorrosion film and the second anticorrosion film has a thickness of 100 to 200 μm.
